(19) United States
(12) Patent Application Publication
(10) Pub. No.: US 2016/0271766 A1
(43) Pub. Date: Sep. 22, 2016

(54) HEX KEY

(71) Applicant: Tuo-Jen Chen, Taichung (TW)

(72) Inventor: Tuo-Jen Chen, Taichung (TW)

(21) Appl. No.: 14/660,942

(22) Filed: Mar. 18, 2015

(51) Int. Cl. B25B 15/00

(52) U.S. Cl. CPC B25B 15/008

(57) ABSTRACT

A hex key has a hexagonal L-shaped body that includes a longer leg and a shorter leg vertically extending from the longer leg. The diameter of the L-shaped body ranges between 2 mm and 10 mm. The length of the shorter leg is greater than or equal to 50 mm. The length of the longer leg is given by the formula 0.3L2≦L1≦0.5L2, where L1 represents the length of the shorter leg, and L2 represents the length of the longer leg.

### BACKGROUND OF THE INVENTION

1. Field of the Invention

The present invention relates to a hexagonal wrench, and more particularly to a hex key that is configured and sized for better gripping and applying torque.

2. Description of the Related Art

A hex wrench, Allen wrench, or key wrench, is a tool known in the art having a hexagonal head used to turn or drive screws, bolts, and the like having hexagonally shaped receiving sockets. In general, the head of a hex wrench has six contact surfaces that can be inserted into a screw or a bolt's hexagonally shaped socket. In operation, torque is applied to the hex wrench to turn the screw or the bolt.

As shown in FIG. 5, a conventional hex wrench 10 has leg members 11, 12 designed to be of different lengths in order to allow a user flexibility when using the wrench in different environments and situations. For example, in a narrow, confined environment, the longer leg 12 of the hexagonal wrench 10 is inserted into the head of the screw (not shown) and the user will apply rotational pressure to the shorter leg 11. If the environment is not so confined, the user may insert the shorter leg 11 of the hexagonal wrench 10 into the head of the screw and apply rotational pressure to the longer leg 12.

Hexagonal wrenches 10 are manufactured and distributed in multiple English and metric sizes in order to facilitate their use with screw heads of multiple sizes. Such wrenches are usually sold in a set which includes wrenches of multiple sizes but are also distributed individually.

When using the hexagonal wrench 10, a user, will insert an end of the hexagonal wrench into the head of the screw and will then exert rotational pressure on the opposite end of the wrench in order to tighten or loosen the screw. Because of the size and dimensions of the hexagonal wrench, it is particularly difficult to exert a great amount of rotational pressure on the hexagonal wrench when the longer leg 12 of the hexagonal wrench 10 is inserted into the head of the screw. Because the hexagonal wrench 10 is typically turned with the user's fingers, the user may also experience scrapes and cuts from the use of hexagonal wrenches in this manner.

A second type of hexagonal wrench is illustrated in FIG. 6, where the hexagonal wrench 10a is formed with a ball end 131 at an end 13 of the longer leg 12, which allows the tool to be used at an angle off-axis to the screw. While providing access to otherwise inaccessible fasteners, thinning of the tool shaft to create the ball shape renders it weaker than the straight-shaft version, limiting the torque that can be applied.

A third type of hexagonal wrench is illustrated in FIG. 7, where the hexagonal wrench 10b further includes a magnet 14 embedded in an end 13 of each of the leg members 11, 12, which allows the tool to attract the screw and prevent the screw falling off. While strengthening the bonding between the tool and the screw, hole drilling of the tool shaft to create the hole to receive the magnet renders it weaker than the original shaft version, limiting the torque that can be applied.

A fourth type of hexagonal wrench is illustrated in FIG. 8, where the hexagonal wrench 10c further includes a plastic handle portion 15 formed at the junction of the leg members 11, 12, which allows the tool to be handled in a comfortable manner. With the handle portion 15, the tool becomes large in size, rendering it hard to carry for use; and the tool cannot be made in a cost-effective manner.

A fifth type of hexagonal wrench is illustrated in FIG. 9, where the hexagonal wrench 10d is T-shaped. The wrench 10d includes a vertical longer lever 12 and a horizontal shorter lever 11 passing through an aperture 160 defined in an end 16 of the longer lever 12. However, the aperture 160 in the longer lever 12 renders the tool weaker, limiting the torque that can be applied. And, the T-shaped wrench 10d is hard to carry either.

A sixth type of hexagonal wrench is illustrated in FIG. 10, where the hexagonal wrench 10e has a handle portion 17 with at least one receptacle 171 to receive the shorter leg 11 of the wrench 10e. As is understood, the handle portion 17 is intended to facilitate the operation of the tool by handling the shorter leg 11. However, the handle portion 17 is suitable for only the shorter leg 11 with one size, and is not suitable for various sizes of the shorter legs 11. Moreover, a gap may be formed between the shorter leg 11 and the handle portion 17, rendering the tool hard to use.

A seventh type of hexagonal wrench is illustrated in FIG. 11, where the hexagonal wrench 10f has a handle portion 18 integrally formed around the longer leg 12. The handle portion 18 is produced by dipping the longer leg 12 in the material such as EVA. However, as is understood that the longer leg 12 now serves as a handle and has no more a drive end for driving a workpiece.

As described above, each type of the hexagonal wrenches has its shortcomings. What is needed is an apparatus which will accept multiple sized hexagonal wrenches and which will further enhance a user's ability to exert rotational pressure on a hexagonal wrench without subjecting the user to personal injury or requiring the use of additional tools which may bend or disfigure the hexagonal wrench.

### SUMMARY OF THE INVENTION

Accordingly, it is an object of the present invention to provide a hex key to satisfy the aforementioned need.

Briefly described, the hex key of the invention has a hexagonal L-shaped body that includes a longer leg and a shorter leg vertically extending from the longer leg. The diameter of the L-shaped body ranges between 2 mm and 10 mm The length of the shorter leg is greater than or equal to 50 mm. The length of the longer leg is given by the formula 0.3L2≦L1≦0.5L2, where L1 represents the length of the shorter leg, and L2 represents the length of the longer leg.

Preferred embodiments of the invention may have the following additional characteristics, either alone or in combination:

If 2 mm≦X≦4 mm, then 50 mm≦L1≦65 mm.

If 4.1 mm≦X≦8 mm, then 65 mm≦L1≦80 mm.

If 8.1 mm≦X≦10 mm, then 80 mm≦L1≦100 mm.

The foregoing and other objectives, features, and advantages of the invention will be more readily understood upon consideration of the following detailed description of the invention, taken in conjunction with the accompanying drawings.

### BRIEF DESCRIPTION OF THE DRAWINGS

FIG. 1 is a side view of a hex key in accordance with the preferred embodiment of the present invention;

FIG. 2 is a side view, illustrating that the shorter leg of the hex key is being handled by an user's hand;

FIG. 3 is another side view, illustrating that the longer leg of the hex key is being handled by the user's hand;

FIG. 4 is a perspective view of a wrench set equipped with a modified hex key each having torx drive heads at opposite ends;

FIG. 5 is a first prior art hex key;

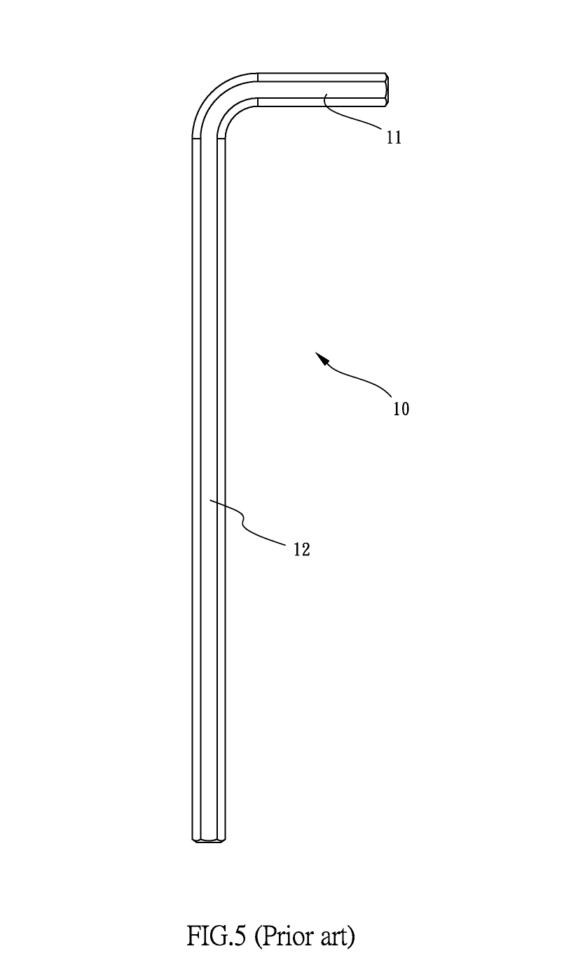

FIG. 6 is a screw to be engaged with a second prior art hex key as indicated by dotted lines;

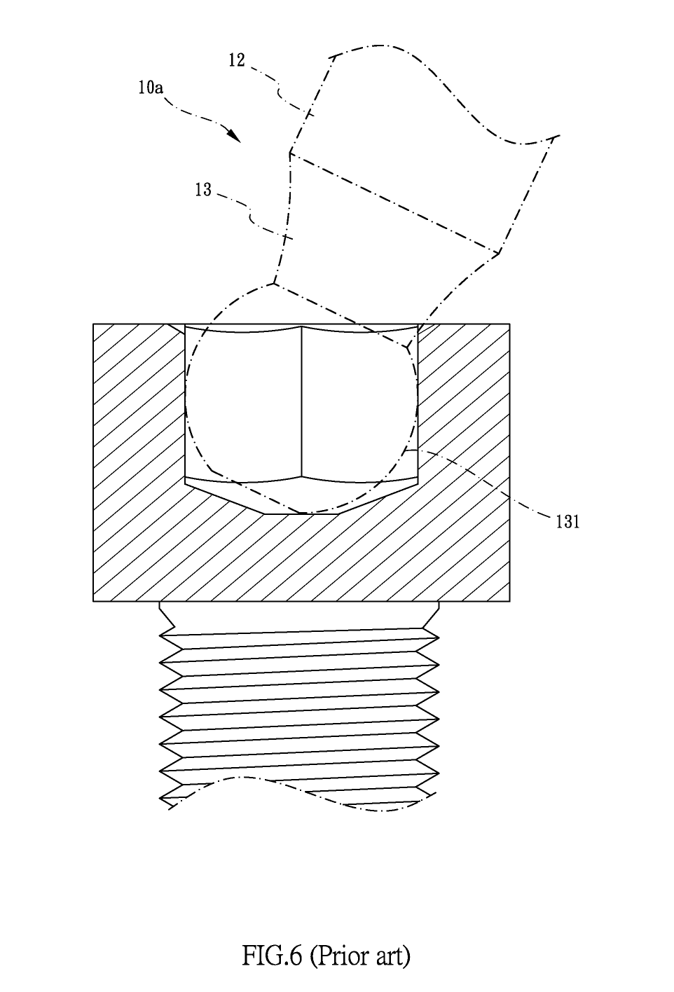

FIG. 7 is a third prior art hex key;

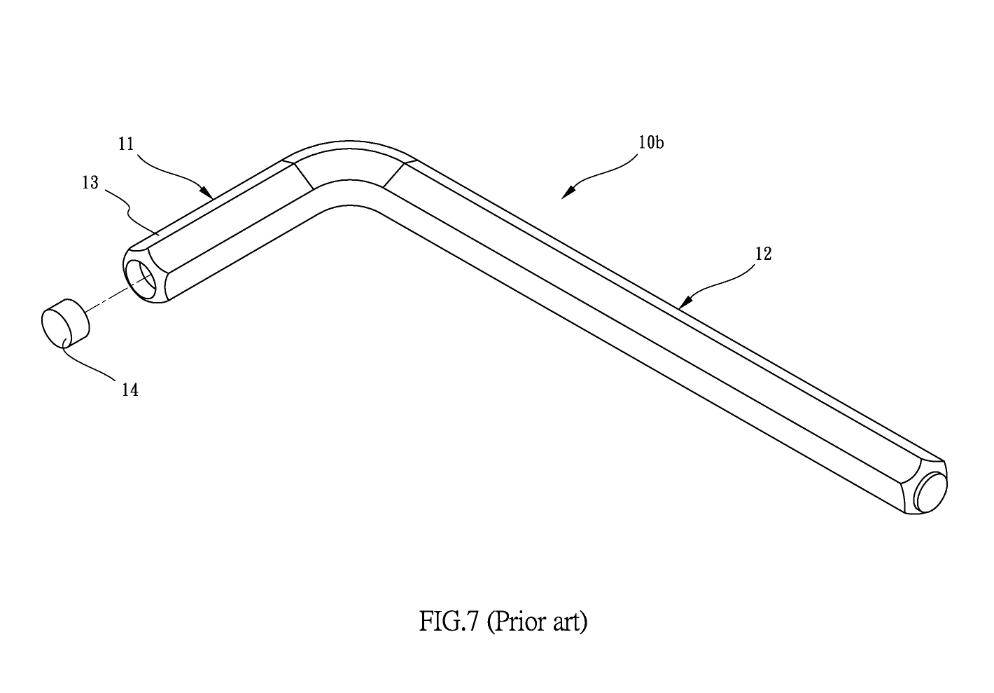

FIG. 8 is a fourth prior art hex key;

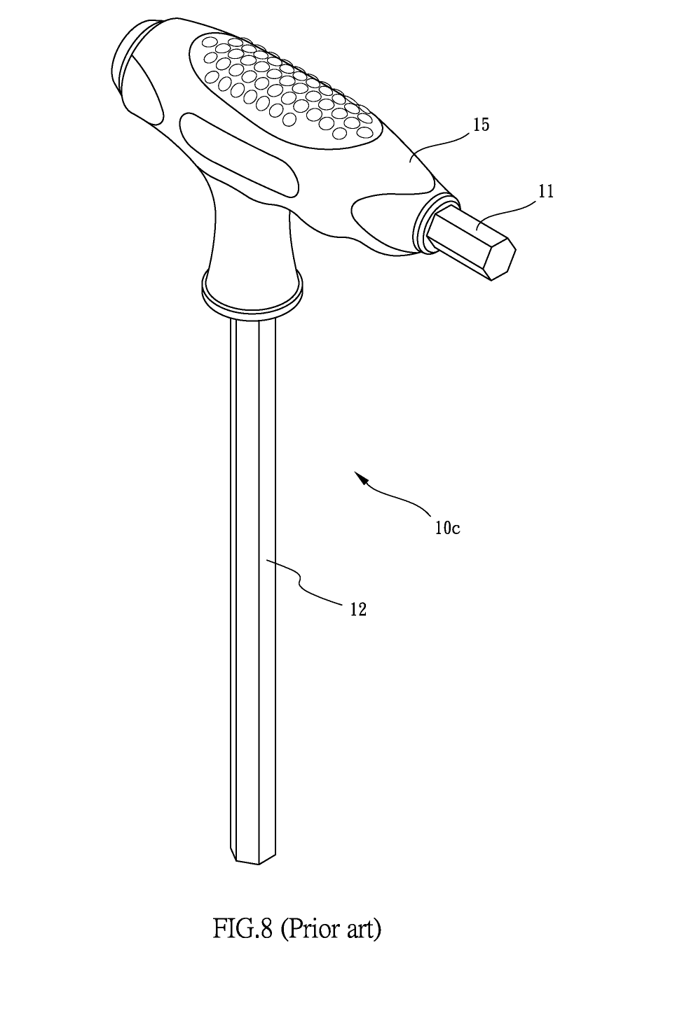

FIG. 9 is a fifth prior art hex key;

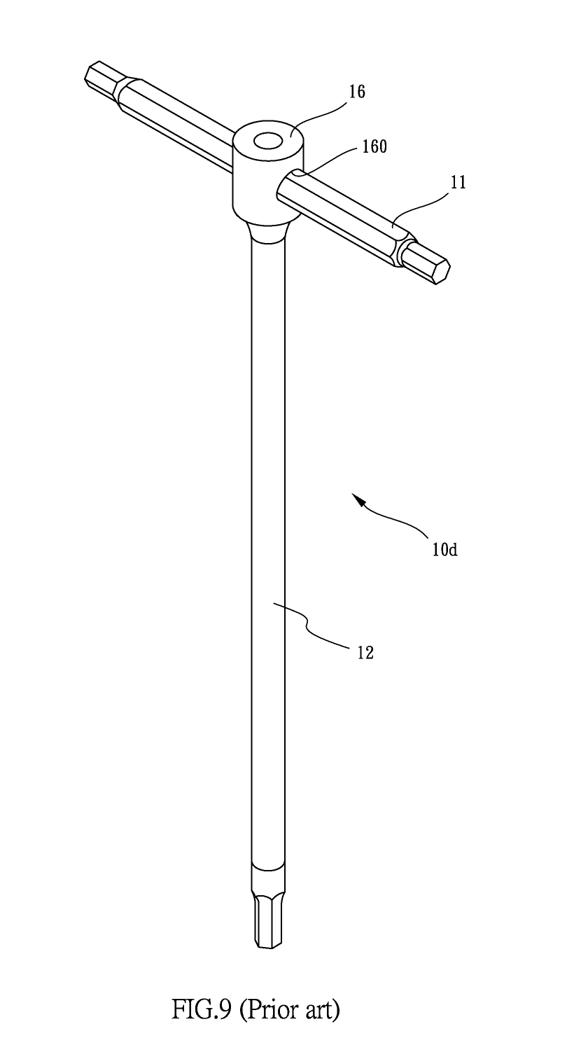

FIG. 10 is a sixth prior art hex key; and

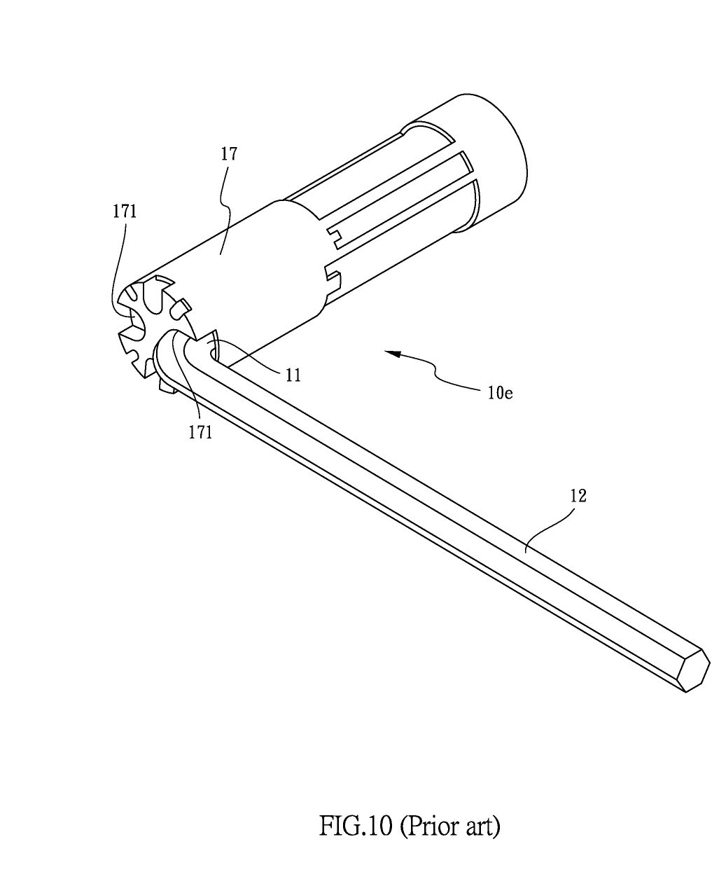

FIG. 11 is a seventh prior art hex key.

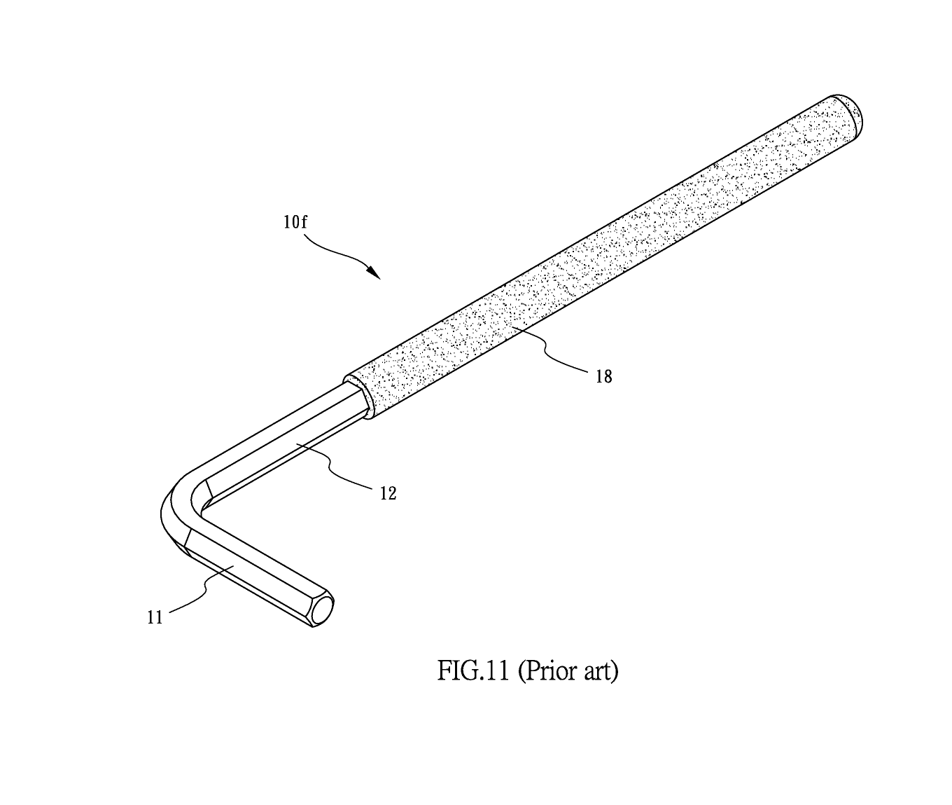

### DETAILED DESCRIPTION OF EMBODIMENTS

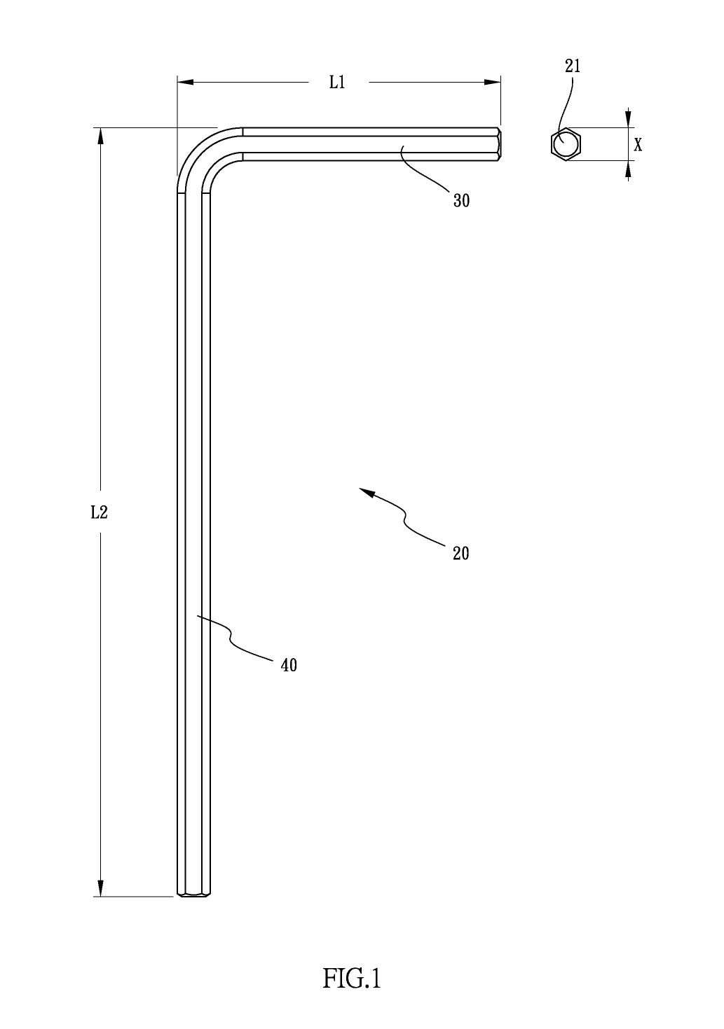

Referring now to the drawings, and particularly to FIG. 1, there is shown a side view of the hex key according to the invention, the hex key including a hexagonal L-shaped body, generally designated 20, with a constant diameter X. Specifically, the hexagonal L-shaped body 20 has a longer leg 40 and a shorter leg 30 vertically extending from the longer leg 40. The shorter and longer legs 30, 40 are provided for driving a workpiece, such as a screw.

In this preferred embodiment, the hexagonal L-shaped body 20 is defined by the following formulas:

2 mm≦X≦10 mm

L1≧50 mm

0.3L2≦L1≦0.5L2

where X represents the diameter of the hexagonal L-shaped body 20; L1 represents the length of the shorter leg 30; and L2 represents the length of the longer leg 40.

Since the length L1 of the shorter leg 30 is greater than or equal to 50 mm, the shorter leg 30 can be well handled by one's hand, as best seen in

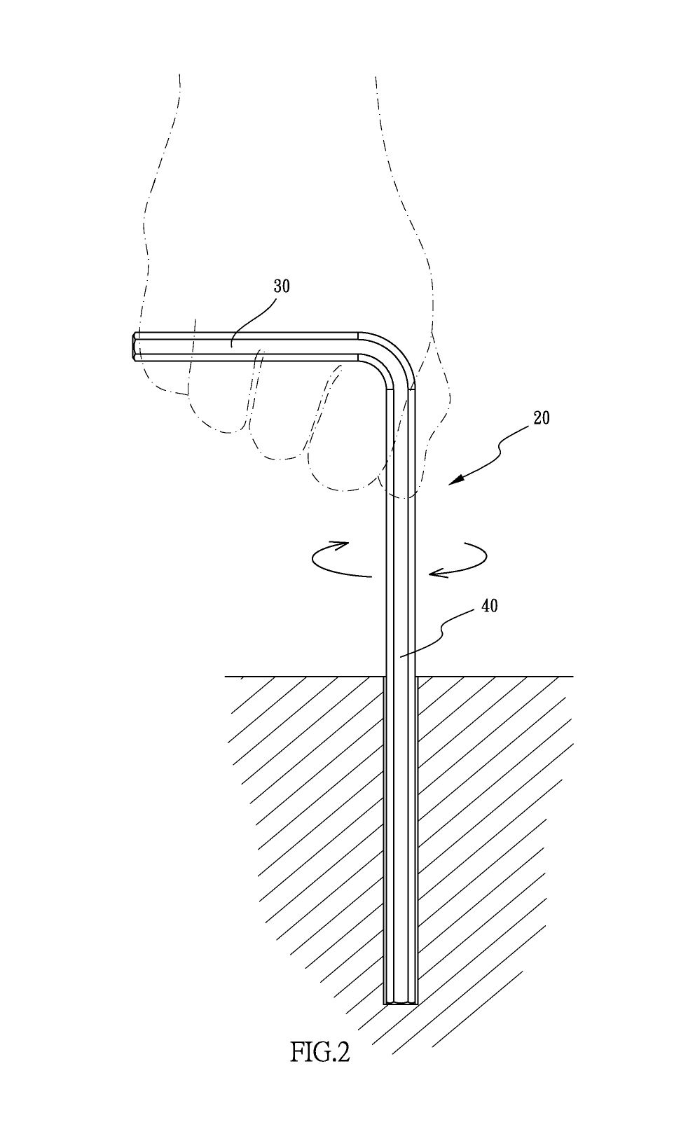

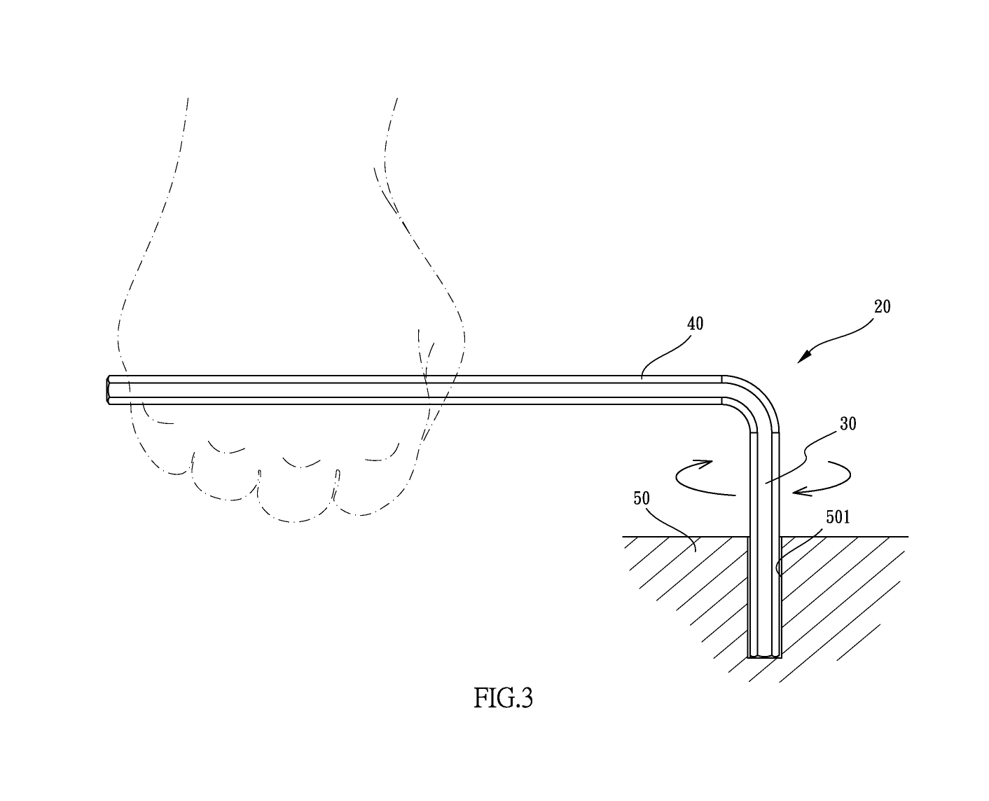

FIG. 2. Note that a person's palm is generally 50 mm in width. Moreover, the longer leg 40 can also be well handled by the hand, as shown in FIG. 3, to apply suitable torque to the workpiece.

Besides, the length L1 of the shorter leg 30 is smaller than or equal to a half of the length L2 of the longer leg 40. This ensures that the shorter leg 30 has enough length with respect to the longer leg 40 and therefore is strong enough to apply torque. If the environment is so confined, the user may insert the longer leg 40 into a deeper hole 501 of a workpiece 50 and apply rotational pressure to the shorter leg 30 with less effort, as shown in FIG. 2.

Furthermore, when the diameter X ranges between 2 mm and 4 mm, it is preferred that the length L1 of the shorter leg 30 ranges between 50 mm and 65 mm. In this manner, the short leg 30 acting as a lever arm can perform the best result and is practical; and the longer leg 40 will not be too long with unnecessary cost.

In another example, when the diameter X ranges between 4.1 mm and 8 mm, it is preferred that the length L1 of the shorter leg 30 ranges between 65 mm and 80 mm. In this manner, the short leg 30 acting as a lever arm can also perform the best result and is practical; and the longer leg 40 will not be too long with unnecessary cost.

In yet another example, when the diameter X ranges between 8.1 mm and 10 mm, it is preferred that the length L1 of the shorter leg 30 ranges between 80 mm and 100 mm. In this manner, the short leg 30 acting as a lever arm can also perform the best result and is practical; and the longer leg 40 will not be too long with unnecessary cost.

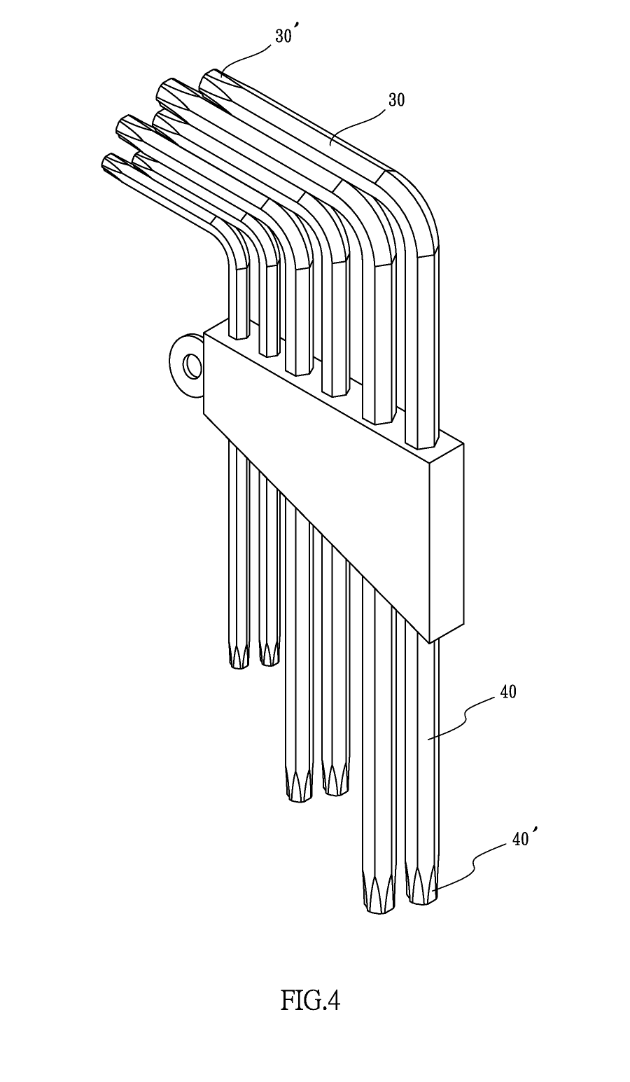

Preferably, as shown in FIG. 4, a torx drive head 30′ or 40′ may be formed on a free end of the longer leg or the shorter leg. The torx drive head 30′ or 40′ is configured for driving a type of screw head characterized by a 6-point star-shaped pattern.

What is claimed is:

1. A hex key comprising a hexagonal L-shaped body including a longer leg and a shorter leg vertically extending from the longer leg, wherein the hexagonal L-shaped body is defined by the following formulas:
2 mm≦X≦10 mm
L1≧50 mm
0.3L2≦L1≦0.5L2
where X represents a diameter of the hexagonal L-shaped body; L1 represents a length of the shorter leg; and L2 represents a length of the longer leg.

2. A hex key as recited in claim 1, wherein if 2 mm≦X≦4 mm, then 50 mm≦L1≦65 mm.

3. A hex key as recited in claim 1, wherein if 4.1 mm≦X≦8 mm, then 65 mm≦L1≦80 mm.

4. A hex key as recited in claim 1, wherein if 8.1 mm≦X≦10 mm, then 80 mm≦L1≦100 mm.

5. A hex key as recited in claim 1, wherein the longer leg of the hexagonal L-shaped body is formed with a torx drive head at an end thereof.

6. A hex key as recited in claim 1, wherein the shorter leg of the hexagonal L-shaped body is formed with a torx drive head at an end thereof.
